(19) United States
(12) Patent Application Publication
(10) Pub. No.: US 2018/0347902 A1
(43) Pub. Date: Dec. 6, 2018

(54) METHOD AND SYSTEM FOR DRYING AN ENCLOSURE

(71) Applicant: Cockerill Maintenance & Ingenierie SA, Seraing (BE)

(72) Inventor: Cleison Luis Webber, Yutz (FR)

(21) Appl. No.: 15/778,650

(22) PCT Filed: Nov. 25, 2016
(86) PCT No.: PCT/EP2016/078900

§ 371 Date: May 24, 2018

(30) Foreign Application Priority Data
Nov. 25, 2015 (EP) 15196344.4

(51) Int. Cl. F26B 5/04; F26B 5/12

(52) U.S. Cl. CPC F26B 5/04; F26B 5/12

(57) ABSTRACT

A method of drying an enclosure includes: extracting air from the enclosure until a first pressure of the enclosure is reached; repeating cycles of raising an enclosure pressure up to a second pressure and lowering the enclosure pressure down to substantially the first pressure (“cycle repetition”), the first and second pressures being within a water evaporation range; interrupting the cycle repetition and extracting the air from the enclosure until a third pressure is reached close to the triple point of water; and bringing the enclosure to an ambient pressure.

### CROSS-REFERENCE TO PRIOR APPLICATIONS

### National Phase

This application is a U.S. National Stage Application under 35 U.S.C. § 371 of International Application No. PCT/EP2016/078900 filed on Nov. 25, 2016, and claims benefit to European Patent Application No. EP 15196344.4, filed on Nov. 25, 2015. The International Application was published in French on Jun. 1, 2017 as WO 2017/089588 A1 under PCT Article 21(2).

### FIELD

The present invention relates to drying an enclosure, such as a vacuum chamber.

### BACKGROUND

After an enclosure has become wet, e.g. as a result of washing, it is necessary, in certain applications, to eliminate all traces of residual water from within the enclosure.

For this purpose, it is known to introduce hot dry air into the enclosure. That method is relatively effective, except, however, when the enclosure presents zones in which water accumulates.

In addition, under certain circumstances, the enclosure contains objects that impede the passage of hot air and prevent it from reaching zones of the enclosure and/or of the objects that remain wet, in particular if those zones are of a shape that encourages water to accumulate. In addition, the use of heat can sometimes damage elements in the enclosure (such as gaskets), or the objects contained therein.

### SUMMARY

An embodiment of the present invention provides a method of drying an enclosure that includes: extracting air from the enclosure until a first pressure of the enclosure is reached; repeating cycles of raising an enclosure pressure up to a second pressure and lowering the enclosure pressure down to substantially the first pressure (“cycle repetition”), the first and second pressures being within a water evaporation range; interrupting the cycle repetition and extracting the air from the enclosure until a third pressure is reached close to the triple point of water; and bringing the enclosure to an ambient pressure.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a diagrammatic view of an installation for performing a method according to an embodiment of the invention;

FIG. 2 is a plot of a curve C showing pressure inside the enclosure while performing a method according to an embodiment of the invention;

FIGS. 3 to 6 are plots superposing a reference pressure curve Cr (enclosure considered to be dry) and the pressure curve C obtained while performing an embodiment of the invention when it is applied to a wet enclosure, each of these figures showing a respective criterion for stopping the drying method; and

FIG. 7 is a fragmentary plot showing a reference curve Cr (for an enclosure that is considered as being dry) and the pressure curve C obtained while performing an embodiment of a method of the invention when it is applied to a wet enclosure, this figure showing another criterion for stopping the drying method.

### DETAILED DESCRIPTION

Embodiments of the present invention improve the drying of an enclosure. Embodiments of the invention remove water from the enclosure as quickly and as completely as possible, and preferably are able to guarantee the absence of water within the enclosure by a method that is indirect.

To this end, embodiments of the invention provide a method of drying an enclosure. The method includes the steps of: connecting the enclosure to means for extracting and introducing air (air extractor and introducer), and to a member for measuring an air pressure inside the enclosure (air pressure measurer); controlling the means to extract air from the enclosure until a first pressure is reached; controlling the means to start repeating cycles of raising pressure up to a second pressure and lowering pressure down to the vicinity of the first pressure, the first and second pressures lying within a water evaporation range; interrupting cycle repetition and causing the means to extract air from the enclosure until a third pressure is reached close to the triple point of water; and returning the enclosure to ambient pressure and disconnecting the means for extracting and introducing air.

Before performing the method, the water contained in the enclosure is liquid. By performing cycles of raising and lowering pressure within a pressure range in which water can vaporize, the method of the invention serves to vaporize all or nearly all of the water contained in the enclosure, without causing water to pass via a state other than vapor. The energy needed to go from the liquid state to the vapor state is smaller than the energy needed to go from the solid state to the vapor state for a given quantity of liquid. The triple point of water is obtained at the temperature of 0° C. and the pressure of 6.01 millibars (mbar). For this temperature and pressure pair, water present in liquid form solidifies and then sublimes, which is not looked for in the method of the invention. Specifically, since vaporization requires less energy, it takes place in a shorter length of time. Likewise, the pressure range for vaporizing water does not require a high level of vacuum and thus makes it possible to use air extraction technology that is not very demanding and that is therefore not very expensive. The method of the invention is thus particularly advantageous.

Other characteristics and advantages of the invention appear on reading the following description of particular, non-limiting implementations of the invention.

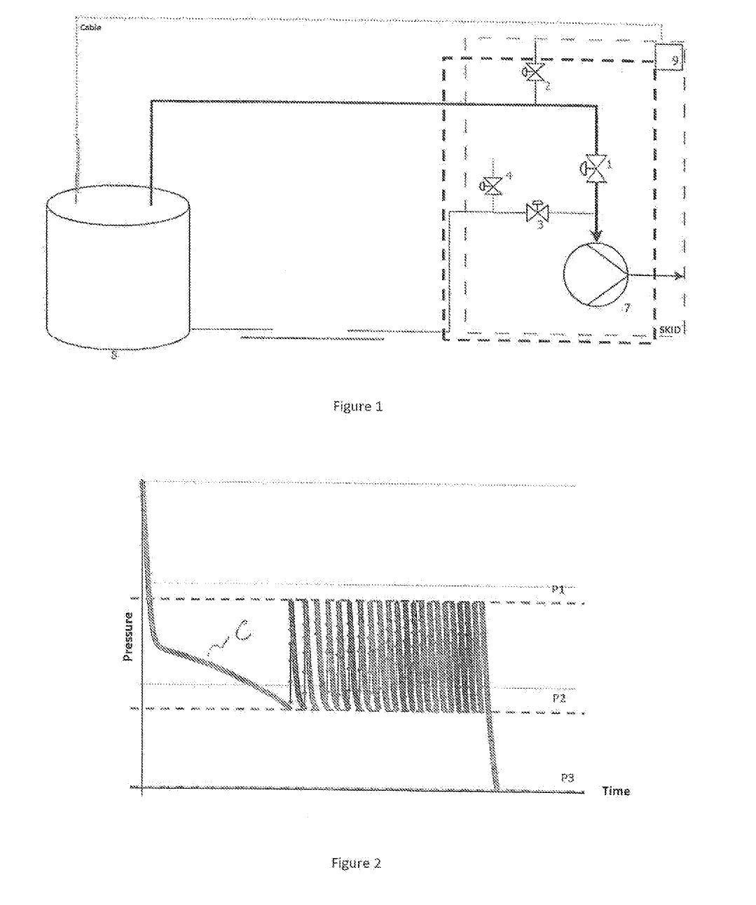

With reference to FIG. 1, the drying method of the invention is applied to an enclosure 8. By way of example, such an enclosure may be:

(i) a tank that has been filled in order to be tested hydraulically and that needs to be emptied and dried before being used;

(ii) a tank that has been washed and that needs to be dried before being used;

(iii) an engine block having setbacks defining enclosures that retain cutting lubricants after machining, which cutting lubricants need to be eliminated by washing and drying before work is carried out on the engine block is used in the remainder of the engine fabrication process;

(iv) a container for storing articles that give off radiation that might produce dihydrogen by radiolysis of water, given that dihydrogen is a compound that is explosive as from a certain concentration; or

(v) a container for storing articles that are sensitive to oxidation, so that container needs to be dry in order to avoid oxidizing articles contained therein.

The drying installation (system) of an embodiment of the invention includes:

(i) a pump 7 connected to a control unit in order to constitute means for extracting air (air extractor) from the enclosure 8;

(ii) a main pipe having one end for connection to the top portion of the enclosure 8 in order to communicate with the inside volume of the enclosure 8, and an opposite end connected to the inlet of the pump 7 via a valve 1, which is controlled by the control unit;

(iii) a secondary pipe having one end for connection to the bottom portion of the enclosure 8 in order to communicate with the inside volume of the enclosure 8, and an opposite end connected to the inlet of the pump 7 via a valve 3 controlled by the control unit;

a valve 2 for connecting the main pipe to the open air, the valve 2 being controlled by the control unit;

(iv) a valve 4 for connecting the secondary pipe to the open air, the valve 4 being controlled by the control unit; and

(v) a pressure sensor 9 for mounting on the enclosure 8 and connected to the control unit.

The control unit is a computer unit having a processor connected to a memory containing a computer program executable by the processor and arranged to perform the drying method of the invention once an operator has connected the inside volume of the enclosure 8 to the main pipe, to the secondary pipe, and to the sensor, which forms the member for measuring the pressure of air (air pressure measurer) inside the enclosure 8.

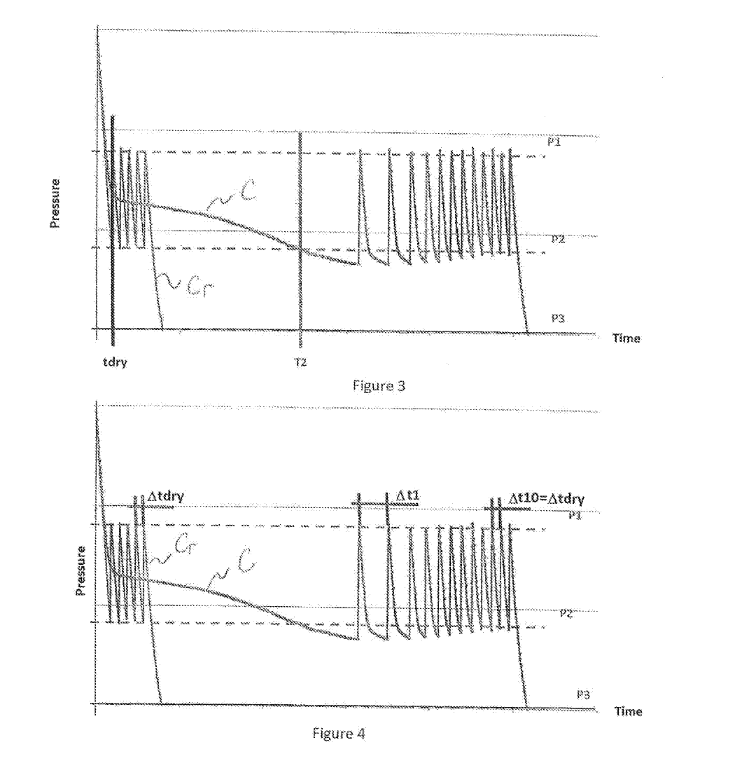

The drying method of an embodiment of the invention includes the following subsequent steps (see FIG. 2).

Firstly, the control unit operates the pump 7 and the valve in order to extract air from the enclosure 8 via the main pipe and the secondary pipe until reaching a pressure P2. When the valves 2 and 4 are closed while the valves 1 and 3 are open, the pump 7 sucks air from the enclosure 8 via the main pipe and the secondary pipe. Sucking air via the secondary pipe also makes it possible to entrain a portion of the liquid water that might accumulate in the bottom portion of the enclosure under the effect of gravity: advantageously, the secondary pipe is provided with a water trap to prevent the water in question from being taken as far as the pump 7.

Once the pressure P2 has been reached, the control unit operates the pump 7 and the valves to begin repeated cycles of raising the pressure up to a pressure P1 and of lowering the pressure down to the vicinity of the pressure P2. This operation is performed by regulating the pressure inside the enclosure by appropriately operating the pump 7 and/or the valves. When the valve 3 is closed and the valve 4 is closed, the pump 7 sucks air from the enclosure 8 via the main pipe. When the valve 4 is open, air is introduced into the enclosure 8 via the secondary pipe (air introducer/provider). Introducing air has two effects: it enables the pressure inside the enclosure to be raised, however it also serves to create a stream of air inside the enclosure 8 that sweeps the enclosure 8 in order to enhance removal of water vapor via the main pipe.

It should be observed that the pressure P2 and the pressure P1 lie within an evaporation range for water.

The control unit then operates the pump 7 and the valves so as to stop repeating those cycles and cause the means to extract air (air extractor) from the enclosure 8 until reaching a third pressure P3 close to the triple point of water.

Once the pressure P3 has been reached, the control unit operates the pump 7 and the valves in order to return the enclosure 8 to ambient pressure. Thereafter, an operator disconnects the pressure sensor and the pipe from the enclosure 8.

The control unit is arranged to interrupt the drying process when a desired degree of humidity has been reached. This degree of humidity is not measured directly but is evaluated as a function of the way pressure in the enclosure 8 varies. Several criteria for stopping the drying process are used.

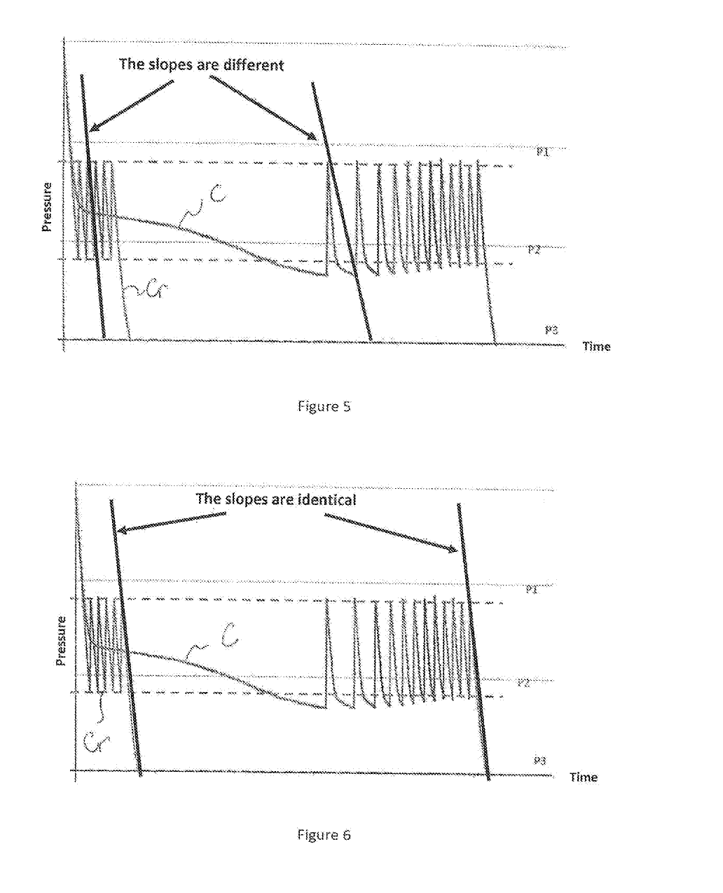

With reference to FIG. 3, the method of an embodiment of the invention in this example includes a step, while extracting air, of measuring a duration T2 needed to reach the pressure P1 and of comparing the measured duration T2 with a reference duration tdry that is needed to reach the first pressure for a desired degree of humidity inside the enclosure. Cycle repetition is started if the measured duration T2 is longer than the reference duration tdry. The enclosure 8 is returned directly to ambient pressure if the measured duration T2 is shorter than or equal to the reference duration tdry: specifically, there is no need to perform cycle repetition under such circumstances.

With reference to FIG. 4, the control unit is arranged to interrupt cycle repetition when the time Δti between two cycles is equal to a reference time Δtdry corresponding to a desired degree of humidity inside the enclosure 8. In FIG. 4, cycle repetition is stopped after cycle 10. In a variant, the control unit is arranged to interrupt repeating cycles when the times Δti between a plurality of successive cycles are equal to one another.

With reference to FIGS. 5 and 6, the control unit is arranged to interrupt cycle repetition when the downward slope from the pressure P1 to the pressure P2 is identical to a reference slope corresponding to a desired degree of humidity in the enclosure. In a variant, cycle repetition is stopped when the downward slope from the pressure P1 to the pressure P2 is equal from one cycle to another.

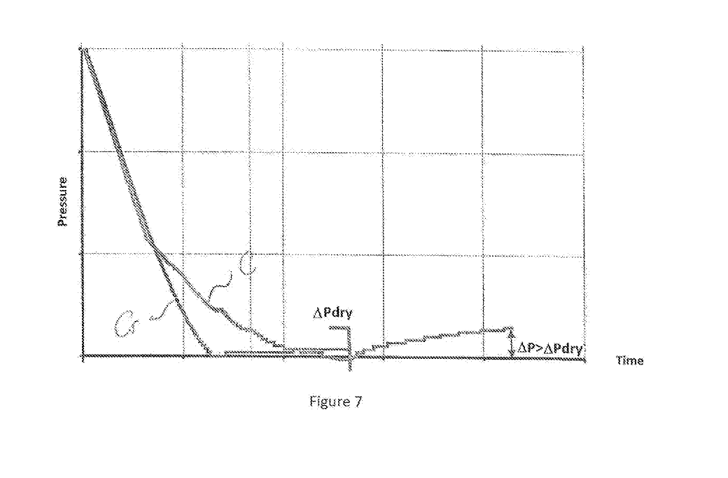

With reference to FIG. 7, once the pressure P3 has been reached, the pressure is observed in order to see whether a natural pressure rise begins. The control unit is arranged to begin repeating cycles again if, during this rise in pressure from the third pressure P3, the pressure variation ΔP after a determined duration is greater than the pressure variation ΔPdry for a desired degree of humidity. If the pressure variation ΔP after a determined duration is less than or equal to the pressure variation ΔPdry, then the control unit operates the pump 7 and the valves in order to return the enclosure 8 to ambient pressure and terminate the method.

Naturally, the invention is not limited to the implementations described but covers any variant coming within the field of the invention.

In particular, it is possible to act on other factors in order to accelerate drying, and in particular on the flow rate of the pump (the greater the flow rate, the faster the drying) and/or on the temperature in the enclosure (the higher the temperature the faster the drying).

It is also possible to orient the enclosure in such a manner as to reduce water accumulation zones.

It may be decided to return the enclosure to ambient pressure when a plurality of stop criteria are satisfied.

As described above, embodiments of the invention provide to a method for drying a chamber (such as a vacuum chamber), including the steps of: connecting the chamber to air extraction and inlet means and to a member for measuring air pressure in the chamber, controlling the means for extracting air from the chamber until a first pressure is reached, controlling the means for initiating repetition of cycles of increasing pressure up to a second pressure and of reducing pressure down to near the first pressure, the first pressure and the second pressure being within a water evaporation range, interrupting the repetition and controlling the means for extracting air from the chamber until a third pressure near the triple point of water is reached, and restoring the chamber to ambient temperature and disconnecting the air extraction and inlet means.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method of drying an enclosure, the method comprising:
extracting air from the enclosure until a first pressure of the enclosure is reached;
repeating cycles of raising an enclosure pressure up to a second pressure and lowering the enclosure pressure down to substantially the first pressure (“cycle repetition”), the first and second pressures being within a water evaporation range;
interrupting the cycle repetition and extracting the air from the enclosure until a third pressure is reached close to the triple point of water; and
bringing the enclosure to an ambient pressure.

2. The method according to claim 1 comprising:
when extracting the air, measuring a duration needed to reach the first pressure, and comparing the measured duration with a reference duration needed to reach the first pressure for a preset degree of humidity in the enclosure;
starting the cycle repetition when the measured duration is longer than the reference duration, and
bringing the enclosure to the ambient pressure when the measured duration is less than or equal to the reference duration.

3. The method according to claim 1, wherein the cycle repetition is interrupted when a time between two cycles is equal to a reference time corresponding to a preset degree of humidity in the enclosure.

4. The method according to claim 1, wherein the cycle repetition is interrupted when a downward slope from the second pressure to the first pressure is identical from one cycle to another.

5. The method according to claim 1, wherein the cycle repetition is interrupted when a downward slope from the second pressure to the first pressure is identical to a reference slope corresponding to a preset degree of humidity inside the enclosure.

6. The method according to claim 1, wherein a new repetition of cycles is begun when, during a rise of the enclosure pressure from the third pressure, a pressure variation after a preset duration is greater than the pressure variation for a preset degree of humidity.

7. A system for drying capable of performing the method according to claim 1, the system comprising:
a pump connected to a control unit for extracting the air from the enclosure;
a main pipe having one end for connecting to a top portion of the enclosure to communicate with an inside volume of the enclosure, and an opposite end connected to an inlet of the pump;
a secondary pipe having one end for connecting to a bottom portion of the enclosure to communicate with the inside volume of the enclosure and provided with an air introduction valve, the air introduction valve capable of being controlled by the control unit; and
a pressure sensor for mounting on the enclosure and connected to the control unit.

8. The method according to claim 1 further comprising:
before first extracting the air, connecting the enclosure to an air extractor and provider capable of extracting and providing the air, and to a an air pressure measurer inside the enclosure; and
after bringing the air to the ambient pressure, disconnecting the enclosure to the air extractor and provider,
wherein the enclosure is at the ambient pressure before first extracting the air.

9. The method according to claim 1, where when repeating cycles of raising the enclosure pressure and lowering the enclosure pressure, the enclosure pressure is lowered down to the first pressure.

10. The method according to claim 1, wherein the third pressure is at the triple point of water.
